(19) United States
(12) Patent Application Publication
(10) Pub. No.: US 2009/0136691 A1
(43) Pub. Date: May 28, 2009

(54) DECORATIVE SHEET, DECORATED MOLDED ARTICLE, AND MOTOR VEHICLE

(75) Inventors: Yasuo Suzuki, Shizuoka (JP); Naohiro Morozumi, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi, Shizuoka-ken (JP)

(21) Appl. No.: 11/718,646

(22) PCT Filed: Sep. 4, 2006
(86) PCT No.: PCT/JP06/17477

§ 371 Date: May 4, 2007

(30) Foreign Application Priority Data
Sep. 13, 2005 (JP) 2005-264892

(51) Int. Cl. B60R 13/00; B32B 5/00

(52) U.S. Cl. 428/31; 428/542.6; 428/172

(57) ABSTRACT

A decorative sheet that can decorate a formed product without diminishing the beauty of its appearance is used to decorate the surface of a formed product. The sheet includes a decoration layer; a base member that supports the decoration layer; an adhesive layer for adhering the decoration layer and the base member onto the formed product; and a flow reducing member for reducing the flow of the adhesive layer. The flow reducing member is provided in the adhesive layer and is made of a material having a higher melting point than that of a material of the adhesive layer.

### BACKGROUND OF THE INVENTION

1. Field of the Invention

The present invention relates to a decorative sheet for use to decorate a formed product and also relates to a formed product decorated with such a decorative sheet and to a motor vehicle including such a decorated formed product.

2. Description of the Related Art

Recently, it was proposed that a decorative sheet be attached to the surface of a formed product as a technique of decorating various types of formed products. A formed product with a decorative sheet can be recycled more easily than a formed product with a painted surface. In addition, a decorated product can have a different type of fine appearance from that of a painted product. That is why a decorative sheet contributes to improving the appearance of formed products noticeably.

FIG. 18 shows an example of a decorative sheet. The decorative sheet 110 shown in FIG. 18 includes a base member 1 of a resin material, a decoration layer 2 arranged on the principal surface 1a of the base member 1, and an adhesive layer 4 deposited on the decoration layer 2. The decoration layer 2 may be formed by a printing process, for example. The adhesive layer 4 may be formed by dry-laminating a resin adhesive, for instance. By attaching this decorative sheet 110 to the surface of the body 121 of a formed product in the order shown in FIGS. 19(a), 19(b) and 19(c), a decorated formed product 120 with a decorated surface can be obtained.

The formed product 121 shown in FIG. 19(a) includes a hemispherical (cuplike) raised portion 121a and therefore has a rugged surface. For that reason, the decorative sheet 110 being attached is stretched so as to follow such ruggedness perfectly. To stretch the decorative sheet 110 effectively, the decorative sheet 110 is typically heated and softened before being attached. A vacuum forming system for making a decorated formed product 120 such as that shown in FIG. 19(c) by using the decorative sheet 110 is disclosed in Japanese Patent Application Laid-Open Publication No. 2002-79573, for example.

If a decorative sheet is attached to a formed product with a rugged surface, however, the resultant decorated formed product may have an uneven gloss on the surface, thus possibly diminishing the beauty of its appearance. FIG. 20 shows a motorcycle fender 122 decorated with the decorative sheet 110. As shown in FIG. 20, a string of uneven gloss 123 appears on a part of the surface of the fender 122 to ruin the beautiful appearance thereof.

### SUMMARY OF THE INVENTION

In order to overcome the problems described above, preferred embodiments of the present invention provide a decorative sheet that can decorate a formed product without diminishing the beauty of its appearance, a formed product decorated with such a decorative sheet, and a motor vehicle including such a decorated formed product.

A decorative sheet according to a preferred embodiment of the present invention is used to decorate a formed product. The sheet includes: a decoration layer; a base member that supports the decoration layer; an adhesive layer for adhering the decoration layer and the base member onto the formed product; and a flow reducing member for reducing the flow of the adhesive layer. The flow reducing member is provided in the adhesive layer and is made of a material having a higher melting point than that of a material of the adhesive layer.

In a preferred embodiment, the flow reducing member is fixed on the decoration layer.

In a preferred embodiment, the adhesive layer is arranged so as to cover the decoration layer and the flow reducing member that is fixed on the decoration layer.

In a preferred embodiment, the melting point of the material of the flow reducing member is higher than that of the material of the adhesive layer by at least about 20° C.

In a preferred embodiment, the elasticity of the material of the flow reducing member is at least twice as high as that of the material of the adhesive layer at about 80° C.

In a preferred embodiment, the flow reducing member has a recess on its surface that is in contact with the adhesive layer.

In a preferred embodiment, the thinnest portion of the flow reducing member with the recess is at most two-thirds as thick as the thickest portion thereof.

In a preferred embodiment, the decorative sheet according to the present invention includes a plurality of flow reducing members.

In a preferred embodiment, the flow reducing members are arranged at regular intervals.

In a preferred embodiment, the melting point of the material of the adhesive layer is lower than the glass transition temperature of the material of the base member by at least about 30° C.

In a preferred embodiment, the material of the base member is a resin.

In a preferred embodiment, the resin is a thermoplastic resin.

A decorated formed product according to a preferred embodiment of the present invention includes a formed product; and a decorative sheet that has been bonded to the surface of the formed product and has one of the structures described above.

In a preferred embodiment, the formed product has been formed by a deep-drawing process and has such a shape that a draw diameter L and a draw depth D satisfy L≧100 mm and D/L≧⅓.

In a preferred embodiment, an outer surface of the decorative sheet bonded to the surface of the formed product has ruggedness corresponding to an arrangement pattern of the flow reducing members.

A motor vehicle according to a preferred embodiment of the present invention includes a decorated formed product having one of the structures described above.

A decorative sheet according to a preferred embodiment of the present invention includes a flow reducing member that reduces the flow of the adhesive layer. That is why when the sheet is bonded onto a formed product, the adhesive is rarely distributed unevenly and a string of uneven gloss can be virtually eliminated. Consequently, a formed product can be decorated with the decorative sheet according to a preferred embodiment of the present invention without diminishing the beauty of its appearance.

Other features, elements, processes, steps, characteristics and advantages of the present invention will become more apparent from the following detailed description of preferred embodiments of the present invention with reference to the attached drawing.

### BRIEF DESCRIPTION OF THE DRAWINGS

FIG. 1 is a perspective view schematically illustrating a decorative sheet according to a preferred embodiment of the present invention.

FIGS. 2(a) and 2(b) are plan views showing exemplary planar shapes of flow reducing members for a decorative sheet.

FIGS. 3(a) and 3(b) are plan views showing exemplary planar shapes of flow reducing members for a decorative sheet.

FIGS. 4(a) and 4(b) are plan views showing exemplary planar shapes of flow reducing members for a decorative sheet.

FIGS. 5(a) and 5(b) are plan views showing exemplary planar shapes of flow reducing members for a decorative sheet.

FIG. 6 is a plan view showing an exemplary planar shape of flow reducing members for a decorative sheet.

FIG. 7 is a plan view showing an exemplary planar shape of flow reducing members for a decorative sheet.

FIG. 8 schematically illustrates how to make the surface of a base member rugged so as to follow the arrangement pattern of flow reducing members.

FIG. 9 is a cross-sectional view schematically illustrating flow reducing members having a recess on their surface.

FIG. 10 is a cross-sectional view schematically illustrating a flow reducing member with a recessed surface.

FIG. 11 is a perspective view schematically illustrating a decorative sheet according to another preferred embodiment of the present invention.

FIG. 12 schematically illustrates a vacuum forming system for use to make a decorated formed product.

FIGS. 13(a) and 13(b) are cross-sectional views schematically illustrating processing steps of a decorated formed product manufacturing process.

FIGS. 14(a) and 14(b) are cross-sectional views schematically illustrating processing steps of the decorated formed product manufacturing process.

FIGS. 15(a), 15(b) and 15(c) are cross-sectional views schematically illustrating processing steps of the decorated formed product manufacturing process.

FIG. 16(a) is a perspective view illustrating an example of a formed product decorated with the decorative sheet of the present invention and FIG. 16(b) is a cross-sectional view of the product as viewed on the plane 16B-16B′ shown in FIG. 16(a).

FIG. 17 is a side view schematically illustrating a motorcycle.

FIG. 18 is a perspective view schematically illustrating a conventional decorative sheet for use to decorate a formed product.

FIGS. 19(a) through 19(c) schematically illustrate a process of decorating a formed product with a decorative sheet.

FIG. 20 is a perspective view illustrating a motorcycle fender decorated with a conventional decorative sheet.

FIGS. 21(a) through 21(c) schematically illustrate a process of decorating a formed product with a conventional decorative sheet.

### DETAILED DESCRIPTION OF PREFERRED EMBODIMENTS

Hereinafter, preferred embodiments of the present invention will be described with reference to the accompanying drawings. It should be noted, however, that the present invention is in no way limited to the following specific preferred embodiments.

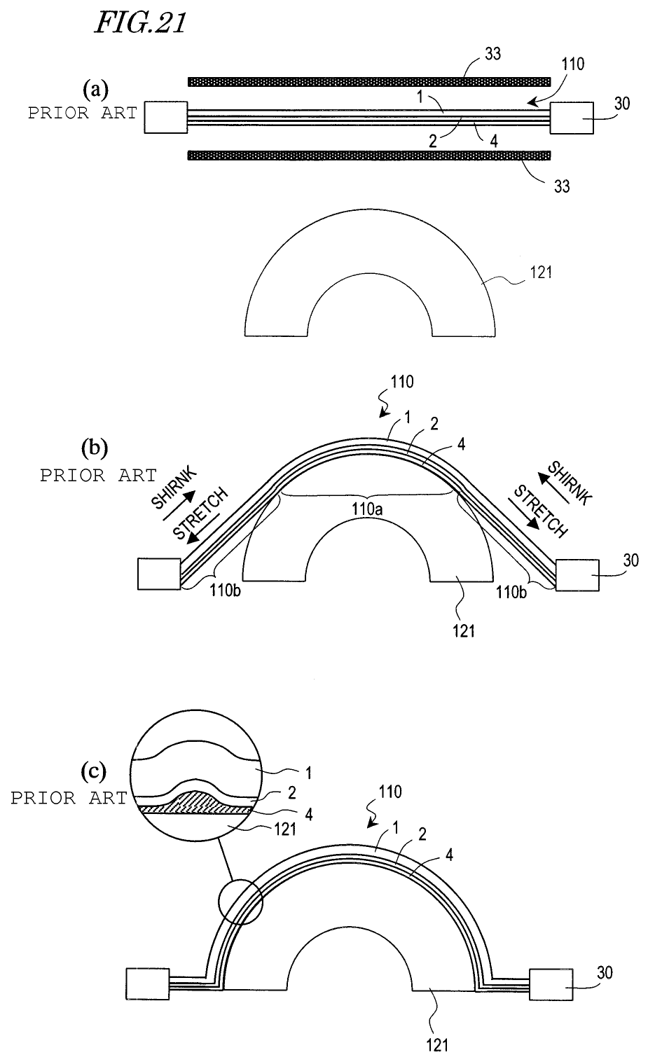

First of all, it will be described why the uneven gloss is produced by the conventional method. FIGS. 21(a) through 21(c) illustrate a conventional decorated formed product manufacturing process.

According to the conventional method, first, as shown in FIG. 21(a), a decorative sheet 110 is fixed onto a gripping frame 30 and then heated with a heater 33. In this process step, the decorative sheet 110 is heated to a temperature at which the base member 1 softens sufficiently and the adhesive layer 4 has good adhesiveness.

Next, as shown in FIG. 21(b), the gripping frame 30 is brought down to press the decorative sheet 110 against a formed product 121. In this process step, first, a portion 110a of the decorative sheet 110 is attached to the formed product 121 as shown in FIG. 21(b).

Subsequently, the decorative sheet 110 is pressurized by introducing compressed air into the space over the decorative sheet 110. As a result, the other portion 110b of the decorative sheet 110 is also bonded onto the formed product 121, which is now covered entirely with the decorative sheet 110 as shown in FIG. 21(c). After that, excessive portions of the decorative sheet 110 are cut off to complete a decorated formed product.

In this series of process steps, the portion 110a of the decorative sheet 110 that contacts with the formed product 121 earlier is cooled more quickly due to conduction of heat into the formed product 121 than the other portion 110b that contacts with the formed product 121 later. For example, if a decorative sheet 110 that has been heated to a temperature of 180° C. to 190° C. is attached, the portion 110b that is still out of contact with the formed product 121 has a temperature of 150° C. to 170° C., but the temperature of that portion 110a in contact with the formed product 121 decreases to somewhere between 60° C. and 120° C., in the process step shown in FIG. 21(b). That is why the flowability of the adhesive is lower in the portion 110a in contact with the formed product 121 than in the non-contacting portion 110b.

Also, in this series of process steps, the base member 1 of the decorative sheet 110 is once stretched so as to fit the surface shape of the formed product 121 closely and then is cooled and shrinks. FIG. 21(b) shows the direction in which the base member 1 is stretched and the direction in which the base member 1 shrinks. As the base member 1 shrinks, the adhesive in the adhesive layer 4 on the base member 1 flows in the direction in which the base member 1 shrinks. The shifted adhesive stays in the vicinity of the boundary between a region where the adhesive has high flowability (i.e., the portion 110b that will contact with the formed product 121 later) and a region where the adhesive has low flowability (i.e., the portion 110a that has already contacted with the formed product 121). As a result, as shown in the enlarged circle in FIG. 21(c), the adhesive layer 4 gets raised around that boundary. Consequently, the decoration layer 2 and the base member 1 located over the adhesive layer 4 also get raised just like the adhesive layer 4, thus making a string of uneven gloss sensible.

As described above, if the conventional decorative sheet is used, the uneven distribution of the adhesive will produce the uneven gloss and diminish the beauty of its appearance.

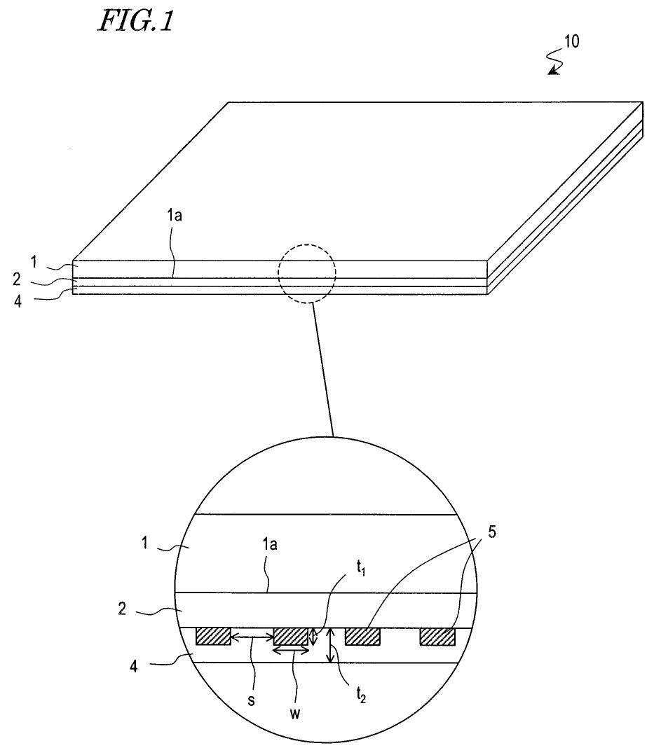

Hereinafter, a decorative sheet according to a preferred embodiment of the present invention will be described in detail with reference to the accompanying drawings. FIG. 1 schematically illustrates a decorative sheet 10 according to this preferred embodiment.

As shown in FIG. 1, the decorative sheet 10 of this preferred embodiment includes a decoration layer 2, a base member 1 that supports the decoration layer 2, and an adhesive layer 4 for bonding the decoration layer 2 and the base member 1 to a formed product.

The decoration layer 2 is arranged on one 1a of the two principal surfaces of the base member 1. The decoration layer 2 may be formed by printing ink, for example. The decorative sheet 10 is heated and stretched when attached onto the formed product. That is why the material of the decoration layer 2 preferably has excellent thermal resistance and bend strength. For example, the ink disclosed in Japanese Patent Application Laid-Open Publication No. 2002-275405 has excellent thermal resistance and bend strength, and therefore, can be used effectively as the material of the decoration layer 2.

The base member 1 is made of a resin, and typically made of a thermoplastic resin such as polycarbonate or acrylic resin. The base member 1 should have some degree of rigidity that is high enough to serve as a sheet base member. That is why the material is preferably selected in view of this respect. Also, since the base member 1 will be located on the uppermost surface of the formed product after the decorative sheet 10 is attached to the formed product, the base member 1 preferably has good weather resistance and good damage resistance. For that reason, the other principal surface of the base member 1, which is opposite to the principal surface 1a with the decoration layer 2, may be covered with a protective layer with good weather resistance and good damage resistance.

The base member 1 preferably has a thickness of no less than about 50 μm and no more than about 1,000 μm. This is because if the base member 1 had a thickness of less than about 50 μm, the sheet would be difficult to handle or its mechanical strength could be too low to avoid tears when the sheet is being attached. On the other hand, if the thickness of the base member 1 exceeded about 1,000 μm, then the sheet could not fit closely the surface of the formed product.

The adhesive layer 4 is preferably made of a urethane adhesive of a urethane resin or a urethane acrylate resin or an acrylic adhesive. To satisfy rigidity required for the product in its operating temperature range, the adhesive in the adhesive layer 4 preferably has an elasticity of about 1×103 Pa to about 1×106 Pa at 80° C. If the elasticity at 80° C. were lower than about 1×103 Pa, then the adhesive would soften so much as to cause some problems when the product is used at a high temperature (e.g., when used outdoors in summer). On the other hand, if the elasticity at 80° C. were higher than about 1×106 Pa, then the adhesive would be too hard to resist impact. To overlay the formed product with the adhesive easily to cover its three-dimensional shape perfectly, the adhesive preferably has an elasticity of about 1×101 Pa to about 1×105 Pa at 180° C. This temperature range is preferred for the following reasons. Specifically, if the elasticity at 180° C. were less than about 1×101 Pa, then the adhesive would flow so easily during the forming process that a pattern representing the adhesive flow could appear on the surface of the formed product. On the other hand, if the elasticity at 180° C. were higher than about 1×105 Pa, bubbles would be easily produced between the adhesive layer 4 and the formed product when the decorative sheet 10 is being attached. The elasticity of the adhesive may be measured by a solid viscosity/elasticity measuring method compliant with JIS K7244-6 (or ISO 6721), for example.

The adhesive layer 4 preferably has a thickness of no less than about 30 μm and no more than about 100 μm. If the adhesive layer 4 had a thickness of less than about 30 μm, then the adhesive layer 4 could become too thin locally (e.g., to about 10 μm or less, which is too small a thickness for an adhesive layer) when the decorative sheet 10 being bonded is stretched. On the other hand, if the adhesive layer 4 had a thickness of greater than about 100 μm, then a portion of the adhesive layer 4 that has not been stretched sufficiently would easily create unevenness when the adhesive shrinks. It should be noted that as the decorative sheet 10 being bonded is stretched, the adhesive layer 4 is also stretched and comes to have a reduced thickness. That is why the thickness of the adhesive layer 4 is preferably increased appropriately according to the surface shape (or the magnitude of the ruggedness) of the formed product.

As shown in the enlarged circle in FIG. 1, the decorative sheet 10 of this preferred embodiment further includes a plurality of flow reducing members 5 that significantly reduce the flow of the adhesive layer 4. These flow reducing members 5 are fixed on the decoration layer 2 and are arranged at regular intervals s. The adhesive layer 4 is formed so as to cover the decoration layer 2 and these flow reducing members 5 that are fixed on the decoration layer 2.

As described above, the flow reducing members 5 arranged in the adhesive layer 4 are made of a material that has a higher melting point than that of the material of the adhesive layer 4. That is why when the decorative sheet 10 is attached, the flow reducing members 5 reduce the flow of the adhesive layer 4. As a result, the adhesive will not be distributed unevenly during the bonding process step and the strings of uneven gloss can be virtually eliminated. Consequently, by using the decorative sheet 10 of this preferred embodiment, a formed product can be decorated without diminishing the beauty of its appearance.

To reduce the flow of the adhesive layer 4 as effectively as possible, the melting point of the material of the flow reducing members 5 is preferably at least about 20° C. higher than that of the material of the adhesive layer 4, and the elasticity of the material of the flow reducing members 5 at 80° C. is preferably at least twice as high as that of the material of the adhesive layer 4.

Also, to reduce the flow of the adhesive layer 4 efficiently, the thickness t1 of the flow reducing members 5 is preferably at least two-thirds as large as the thickness t2 of the adhesive layer 4 and the width w of the flow reducing members 5 is preferably no less than about 200 μm and no more than 5 mm. If the width w were less than about 200 μm, the flow reducing members could not overcome the flow pressure of the adhesive and could fail to reduce the flow sufficiently. On the other hand, if the width w were more than about 5 mm, then the flow reducing members might block even an appropriate flow of the adhesive (i.e., the flow that follows up with the base member 1 being stretched).

Furthermore, to reduce the flow of the adhesive layer 4 efficiently, the flow reducing members 5 are preferably arranged at an interval of no less than about 2 mm and no more than about 10 mm. If the interval s were less than about 2 mm, the flow reducing members might block even an appropriate flow of the adhesive (i.e., the flow that follows up with the base member 1 being stretched). On the other hand, if the interval s exceeded about 10 mm, then the flow reducing members could not resist the flow pressure of the adhesive and could fail to reduce the flow sufficiently.

Typically, the flow reducing members 5 have a thickness t1 of about 5 μm to about 50 μm, a width of about 1 mm to about 2 mm and an interval s of about 1 mm to about 5 mm.

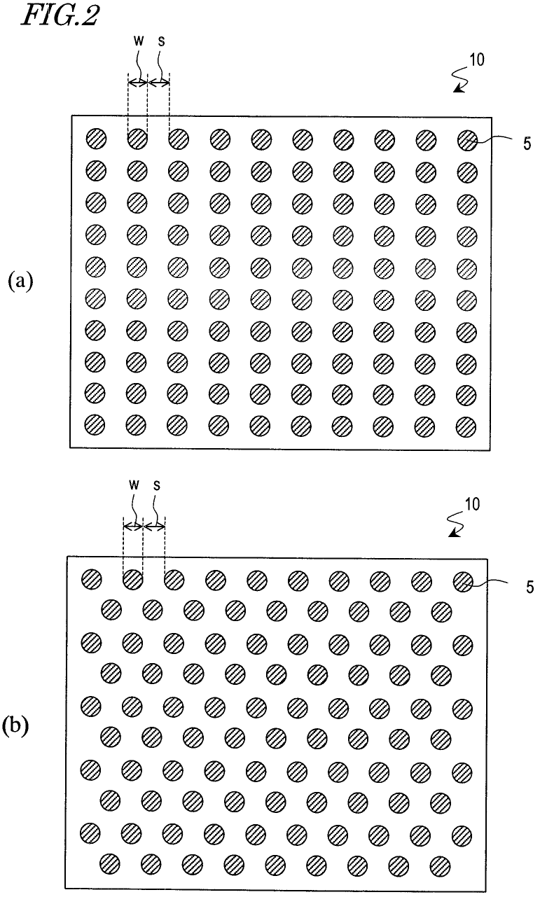

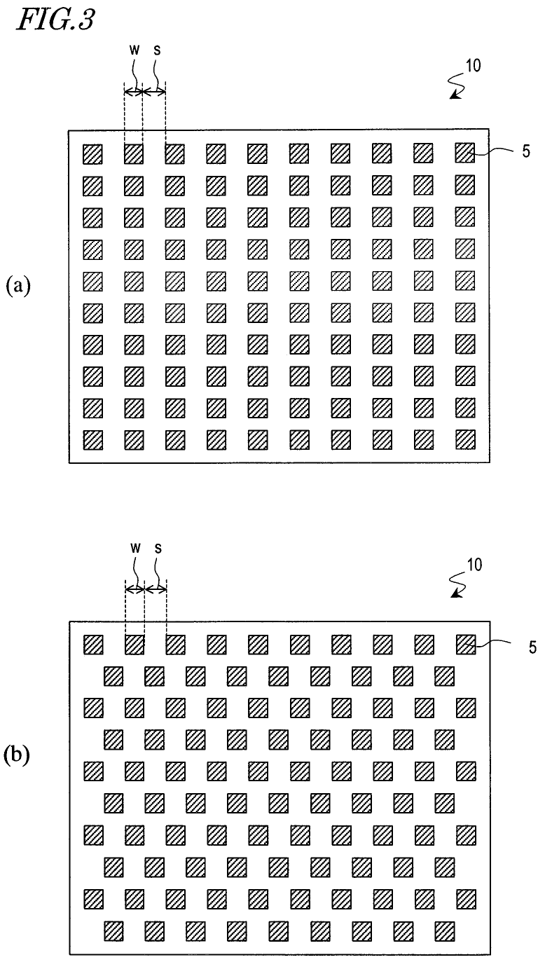

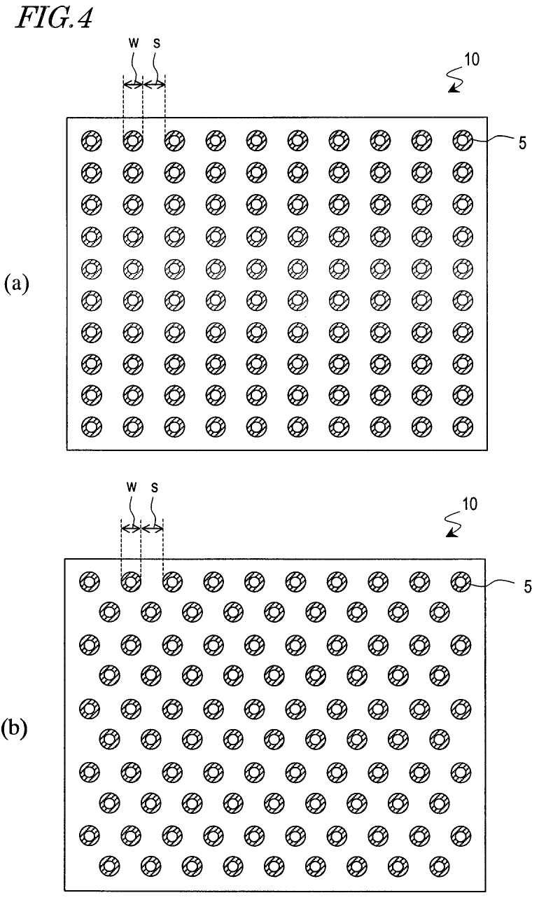

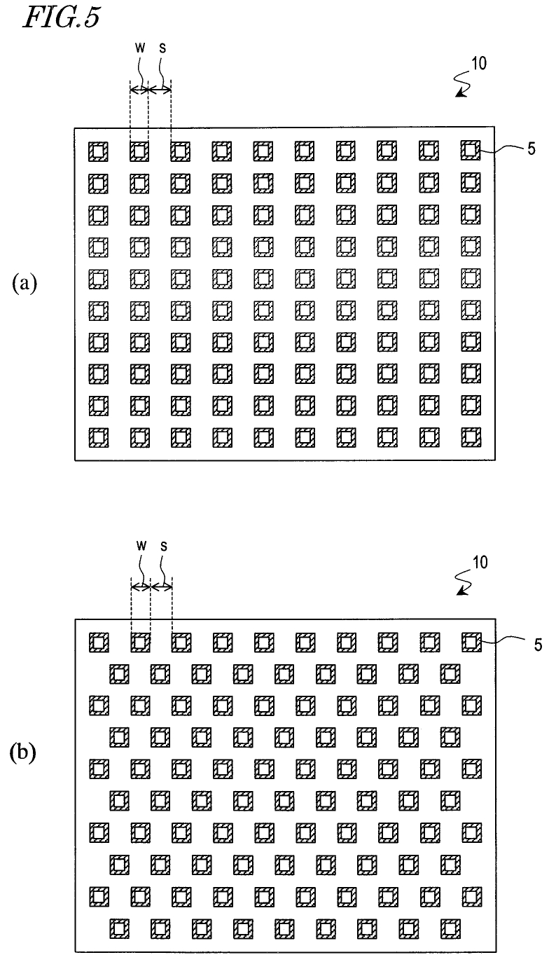

The planar shape of the flow reducing members 5 (as viewed perpendicularly to the principal surface of the base member 1) may be either substantially circular as shown in FIGS. 2(a) and 2(b) or substantially rectangular as shown in FIGS. 3(a) and 3(b), or may even be any of various other shapes (e.g., a rectangular polygonal shape). Alternatively, the flow reducing members 5 may also have a substantially circular ringlike planar shape as shown in FIGS. 4(a) and 4(b) or a polygonal ring-like planar shape as shown in FIGS. 5(a) and 5(b).

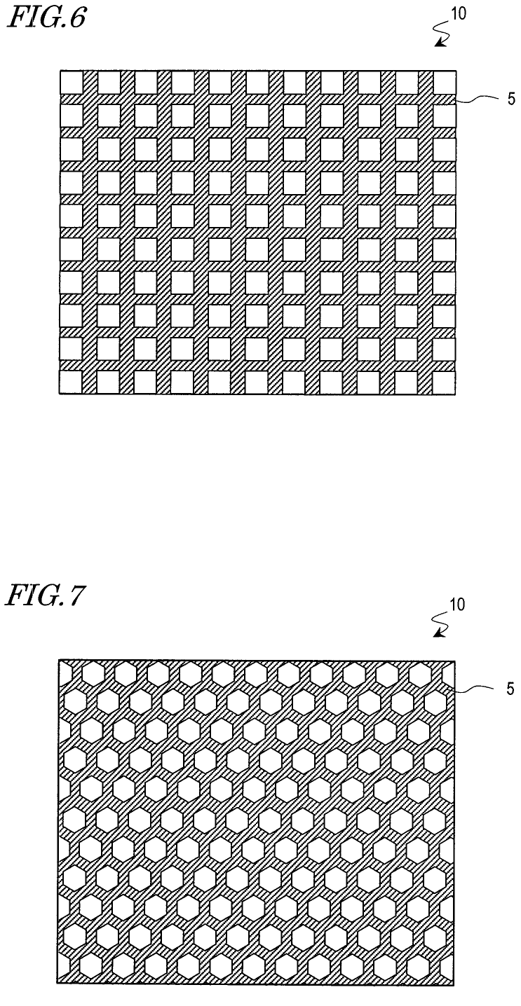

In the preferred embodiment described above, arrangements of multiple flow reducing members 5 have been described as specific examples. However, a single continuous member such as that shown in FIG. 6 or 7 may be provided as the flow reducing member 5. Specifically, the flow reducing member 5 shown in FIG. 6 has a grating shape, while the flow reducing member 5 shown in FIG. 7 has a honeycomb shape with hollow holes. The flow of the adhesive layer 4 can also be reduced effectively even by using any of these alternative flow reducing members 5.

The flow reducing members 5 are typically made of a resin. Examples of preferred materials for the flow reducing members 5 include thermosetting resins such as urethane acrylate, acrylic, epoxy, and phenoxy resins, elastomers, and silicon rubbers. The flow reducing members 5 may be formed by depositing and patterning any of these resins on the decoration layer 2 by a printing process, for example. Naturally, the flow reducing members 5 do not have to be formed by a printing process. Alternatively, the flow reducing members 5 may also be formed by a dry film process that is often adopted in an IC manufacturing process or by putting the flow reducing members into the adhesive in advance and then distributing those members when the adhesive layer 4 is formed.

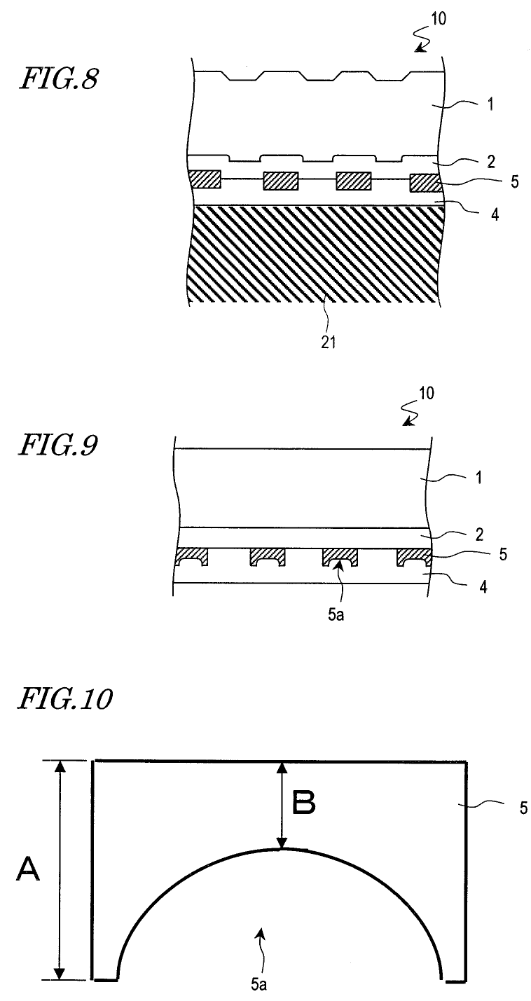

If the flow reducing members 5 are at least as hard as the decoration layer 2, then level differences will be created on the respective surfaces of the decoration layer 2 and the base member 1 when the decorative sheet 10 is attached to the formed product 21 as shown in FIG. 8. As a result, a regular rugged pattern, corresponding to the arrangement pattern of the flow reducing members 5, can be formed on the surface of the decorated formed product (i.e., on the outer surface of the decorative sheet 10). In a situation where such a rugged pattern has been formed on the surface of the decorated formed product, even if uneven gloss were produced due to non-uniform distribution of the adhesive, that unevenness would be much less sensible. In addition, since such a rugged pattern is recognized as a dimple pattern, its decorative effect would make the product's appearance even more attractive and impressive for potential buyers.

Also, as shown in FIG. 9, the flow reducing members 5 preferably have a recess 5a on their surface in contact with the adhesive layer 4. If the surface of the flow reducing members 5 has such a shape, the adhesive will be retained in the recess 5a and the flow of the adhesive layer 4 can be reduced highly effectively. To retain the adhesive in the recess 5a effectively, the thickness B of the thinnest portion of the flow reducing member 5 is preferably two-thirds or less of the thickness A of the thickest portion thereof. The flow reducing member 5 with the recess 5a may be formed by a screen printing process, for example.

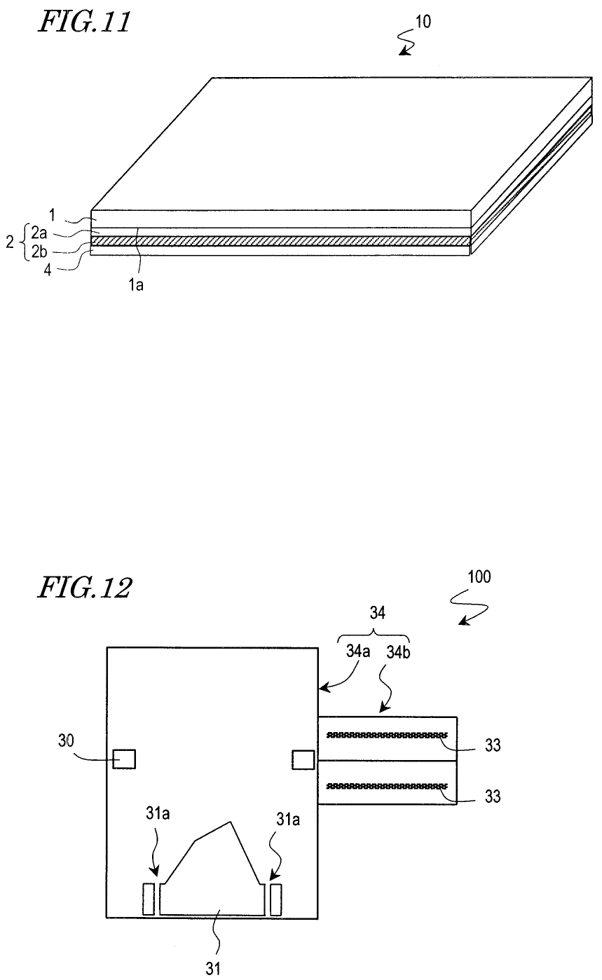

The decoration layer 2 does not have to be a single layer as shown in the drawings but may include multiple layers. Also, the decoration layer 2 may include not only an ink layer 2a but also a metal layer 2b as shown in FIG. 11. If the decoration layer 2 includes a metal layer 2b, the decorative sheet 10 can have a metallic color, which gives the product a great-looking metallic appearance, due to the metallic gloss of the metal layer 2b.

The metal layer 2b may be made of tin, aluminum, gold, copper, zinc, silver, indium or an alloy thereof. Optionally, the decoration layer 2 may consist essentially of the metal layer 2b without the ink layer 2a. The metal layer 2b may be formed by an evaporation process, for example. Specifically, the metal layer 2b may be formed by evaporating a metal directly on the base member 1 (or on the ink layer 2a). Alternatively, a metal may be evaporated on a carrier film provided separately and then the stack may be bonded onto the base member 1 (or the ink layer 2a) to form the metal layer 2b.

According to the conventional method, if a decorative sheet including a metal layer were used, then the string of uneven gloss would become even more noticeable to diminish the beauty of its appearance significantly. For that reason, the present invention is even more effective in a situation where the decorative sheet 10 includes a metal layer 2b.

Also, the glass transition temperature of the material of the base member 1 is typically higher than the melting point of the material of the adhesive layer 4. According to the conventional method shown in FIGS. 21(a) through 21(c), if there were a big difference between the glass transition temperature of the material of the base member 1 and the melting point of the material of the adhesive layer 4 (i.e., if the melting point of the material of the adhesive layer 4 were much lower than the glass transition temperature of the material of the base member 1), then the adhesive would have so high flowability as to be distributed unevenly and diminish the beauty of its appearance easily when the decorative sheet 110 is heated and softened. In contrast, according to preferred embodiments of the present invention, even if the melting point of material of the adhesive layer 4 is much lower than the glass transition temperature of the material of the base member 1 by about 30° C. or more, for example, fine appearance without gloss unevenness is still realized.

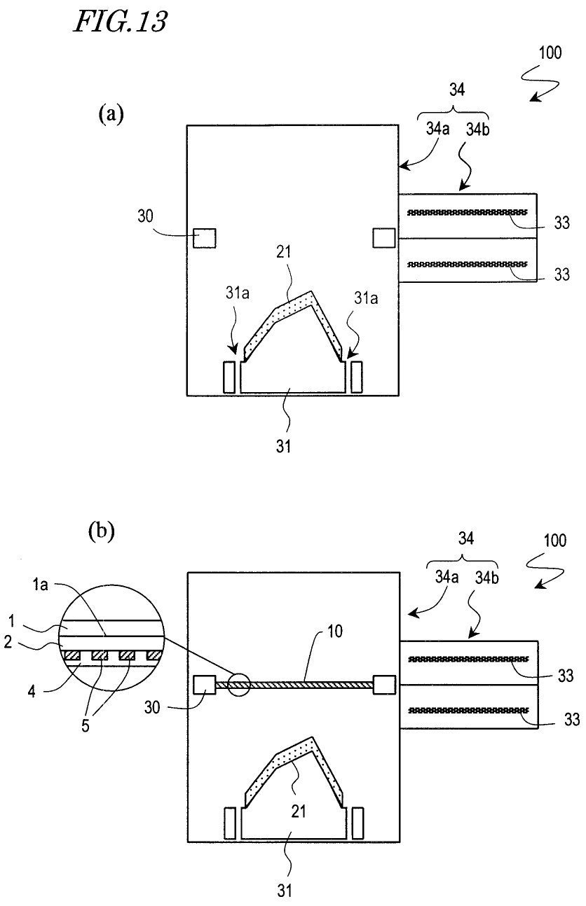

Hereinafter, a method of making a decorated formed product using the decorative sheet 10 will be described with reference to FIGS. 12 through 15. FIG. 12 schematically illustrates a vacuum forming system 100 for use to make a decorated formed product. FIGS. 13 through 15 are cross-sectional views schematically illustrating respective processing steps of the manufacturing process.

The vacuum forming system 100 shown in FIG. 12 includes a gripping frame 30 to grip a decorative sheet 10 thereon, a supporting stage 31 for supporting a formed product thereon, a heater (such as a far-infrared heater) 33 for heating the decorative sheet 10, and a vacuum vessel 34 that stores all of these members.

The vacuum vessel 34 includes a main vessel 34a that stores the gripping frame 30 and the supporting stage 31, and a sub-vessel 34b that stores the heater 33. When the decorative sheet 10 is heated, the heater 33 is introduced into the main vessel 34a.

The supporting stage 31 has a plurality of openings 31a, through which the air inside the main vessel 34a can be exhausted. Although not shown in FIG. 12, a mechanism for introducing a gas from outside of this system into the main vessel 34a (e.g., a hose connected to an external pump) is also provided for the main vessel 34a.

Using this vacuum forming system 100, a decorated formed product may be made in the following manner, for example.

First, as shown in FIG. 13(a), a formed product 21 is provided and mounted on the supporting stage 31. The formed product 21 may be made of a resin material, a metallic material or any other suitable material by a known technique. For example, the formed product 21 may be made of a resin material by an injection molding process.

Thereafter, as shown in FIG. 13(b), a decorative sheet 10 is provided and fixed onto the gripping frame 30. As partially enlarged in FIG. 13(a), the decorative sheet 10 includes flow reducing members 5 in its adhesive layer 4.

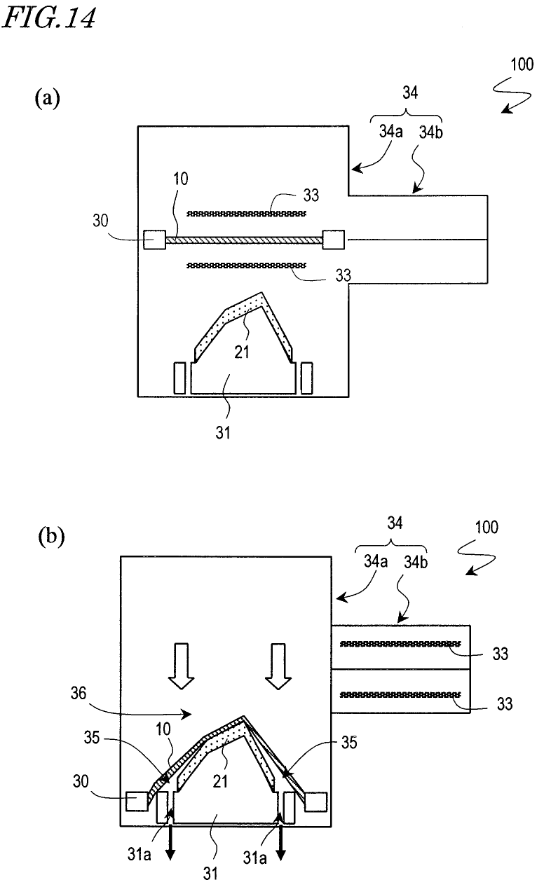

Subsequently, as shown in FIG. 14(a), the decorative sheet 10 is heated with the heater 33, thereby softening the decorative sheet 10. In this process step, the decorative sheet 10 is preferably heated to a temperature of (TA−40)° C. to (TA+20)° C., where TA is the load deflection temperature of the base member 1. If the decorative sheet 10 were heated to a temperature lower than (TA−40)° C., then the base member 1 would not be deformed easily and could crack when bonded to the formed product and formed into a desired shape or could even be non-formable at all. On the other hand, if the decorative sheet 10 were heated to a temperature higher than (TA+20)° C., the sheet being heated could stretch too much to be formed into a desired shape.

Typically, the decorative sheet 10 is heated to a temperature that is equal to or higher than the load deflection temperature TA of the base member 1. Also, in this process step, the decorative sheet 10 is preferably heated to a temperature that is approximately 20 to 30° C. higher than the lowest adhesion temperature of the adhesive layer 4 to ensure good adhesiveness for the adhesive layer 4. The load deflection temperature is measured under a prescribed load (of about 0.45 MPa, for example) compliant with the ASTM D648 standard, which is a standard method of measuring a load deflection temperature that was set by the American Society for Testing and Materials. According to this standard, the temperature of a test piece is raised under a prescribed bending load and the temperature at which the deflection of the piece reaches a predetermined value is defined as the load deflection temperature.

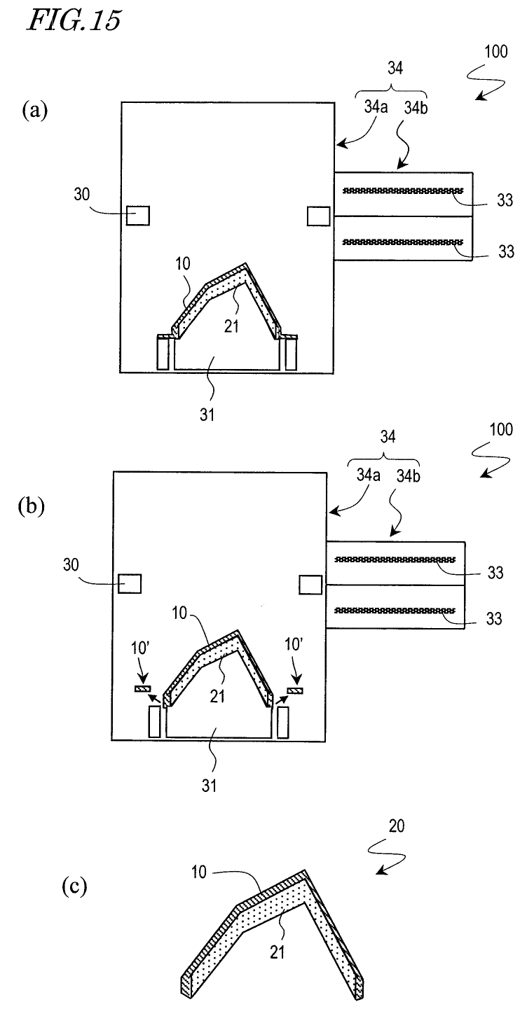

Thereafter, as shown in FIG. 14(b), the decorative sheet 10 is brought down toward the formed product 21 and then the pressure in the space 35 between the decorative sheet 10 and the formed product 21 is reduced, thereby bonding the decorative sheet 10 onto the formed product 21 as shown in FIG. 15(a). If the pressure in the space 35 between the decorative sheet 10 and the formed product 21 is reduced, then the decorative sheet 10 will be pressed against the formed product 21 with uniform pressure. As a result, the sheet 10 can be bonded to the product 21 effectively. In this preferred embodiment, the space 36 over the decorative sheet 10 is also pressurized, thereby making an even bigger pressure difference. Consequently, the decorative sheet 10 can be bonded even more quickly. The pressure in the space 35 may be reduced by exhausting the air in the space 35 through the openings 31a of the supporting stage 31 using a vacuum pump, for example. On the other hand, the pressure in the space 36 may be increased by supplying compressed air thereto using a compressor, for example. In this bonding process step, the decorative sheet 10 is stretched and formed so as to fit the surface shape of the formed product 21 closely. If the decorative sheet 10 were too thin, then the beauty of its appearance would diminish. That is why this process step is preferably carried out such that the thickness of the decorative sheet 10 bonded becomes at least about 0.4 times as large as, more preferably about 0.5 or more times as large as, the original thickness.

Subsequently, as shown in FIG. 15(b), an excessive portion 10′ of the decorative sheet 10 is trimmed with a rotating blade or any other cutter, and then the formed product 21 is removed from the supporting stage 30, thereby completing a formed product 20 with a decorated surface as shown in FIG. 15(c).

The decorative sheet 10 of this preferred embodiment includes flow reducing members 5 for reducing the flow of the adhesive layer 4. That is why even if the base member 1 shrinks in any of this series of process steps, the flow of the adhesive layer 4 due to the shrinkage can be virtually blocked. For that reason, the adhesive is not easily raised locally unlike the adhesive shown in FIG. 21(c). Thus, in the decorative sheet 10, the adhesive is rarely distributed unevenly, and therefore, the string of uneven gloss can be virtually eliminated.

As described above, by using the decorative sheet 10 of this preferred embodiment, a formed product can be decorated without diminishing the beauty of its appearance. For that reason, the decorative sheet 10 can be used effectively to decorate a formed product with significant ruggedness, e.g., to decorate a deep-drawn formed product.

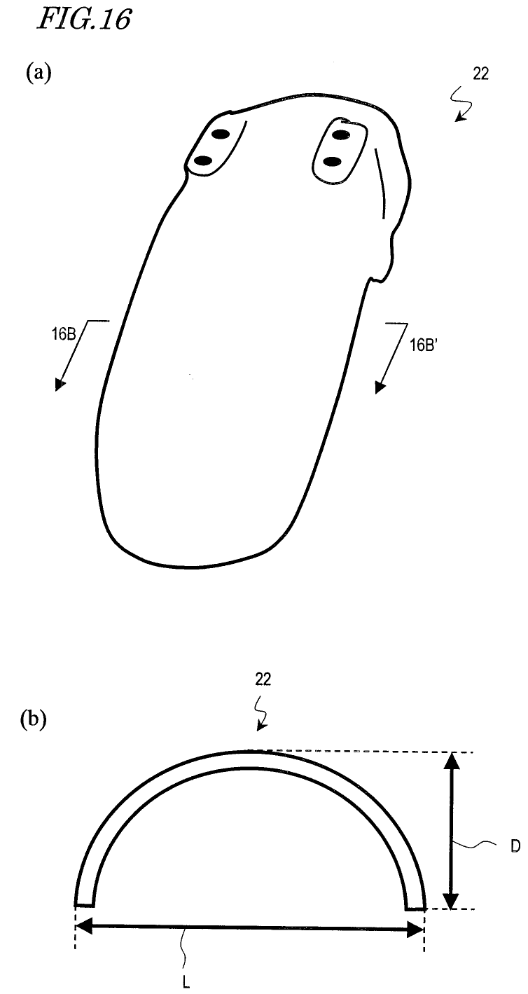

FIGS. 16(a) and 16(b) illustrate an example of a deep-drawn formed product. The motorcycle fender 22 shown in FIGS. 16(a) and 16(b) has a shape with a large D/L ratio (which will be referred to herein as a “draw ratio” and), which is the ratio of the draw depth D to the draw diameter L (i.e., the width of a cross section of a formed product in the latitudinal direction). That is to say, the fender 22 has a deep-drawn shape. By using the decorative sheet 10, the diminution in the beauty of appearance due to the uneven distribution of the adhesive can be minimized, and therefore, even a formed product with a relatively large draw diameter L and a rather high draw ratio D/L can also be decorated effectively. For example, according to the conventional method, if a formed product, of which the draw diameter L and draw depth D satisfy L≧100 mm and D/L≧⅓, is decorated, the beauty of its appearance diminishes significantly. However, by using the decorative sheet 10 of this preferred embodiment, even a formed product with such a shape can also be decorated effectively without diminishing the beauty of its appearance.

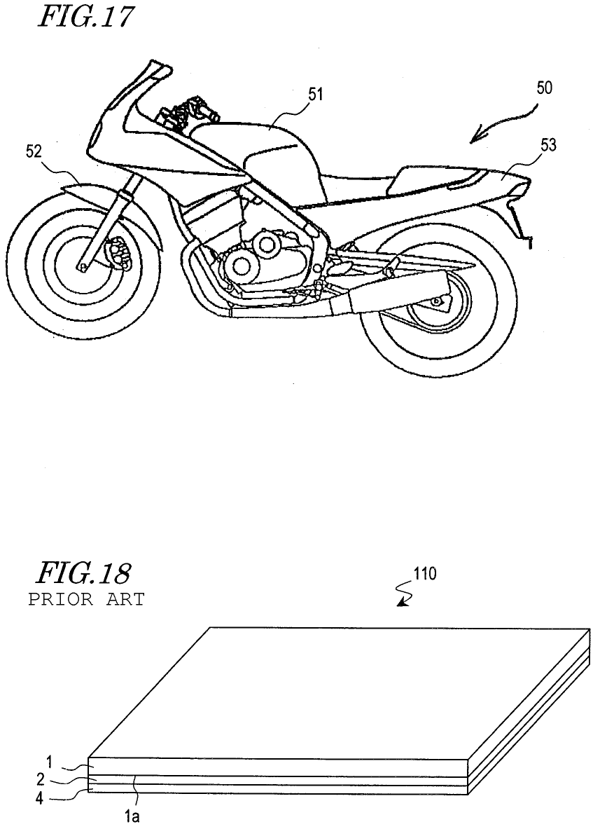

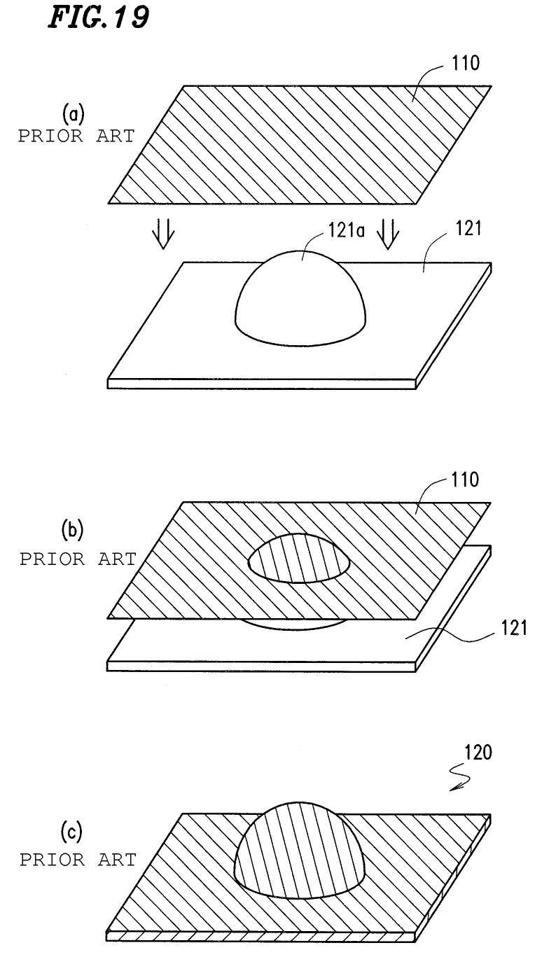

A formed product decorated with the decorative sheet 10 of this preferred embodiment can be used effectively as an interior or exterior member for a motor vehicle or as an exterior member for a consumer electronic appliance. For example, the formed product can be used effectively as the tank housing 51, the front fender 52 or the tail cowl 53 of a motorcycle 50 as shown in FIG. 17. As used herein, the “motor vehicle” broadly refers to a self-propelled vehicle or machine that is used to transport passengers or goods or to transfer an object. Examples of motor vehicles include passenger cars, motorcycles, buses, trucks, tractors, airplanes, motorboats, and civil engineering vehicles. The motor vehicles include not only vehicles equipped with an internal combustion engine such as a gasoline engine but also those equipped with an electric motor.

Also, in the formed product decorated with the decorative sheet 10 of this preferred embodiment, the decoration layer 2 is protected by the base member 1 and can maintain fine appearance for a long time. For that reason, the formed product decorated with the decorative sheet 10 can be used outdoors particularly effectively in ships, outboard engines, water vehicles, all terrain vehicles (ATVs), snowmobiles, two wheelers, and golf cars.

The present inventors actually made a decorated formed product using the decorative sheet 10 of this preferred embodiment and evaluated its appearance. The results of the evaluation will be described below.

### Example #1

A polycarbonate film Eupiron D02, produced by Mitsubishi Gas Chemical Co., Inc. and having a thickness of 0.5 mm, was used as a base member and a pattern was printed on this film with ink to make a decoration layer. On this decoration layer, circular flow reducing members of a urethane acrylate resin, each having a diameter of 4 mm and a thickness of 10 μm, were arranged at an interval of 4 mm. The flow reducing members were formed by a printing process. An adhesive layer of a urethane based adhesive UNH790, produced by Nihon Unipolymer Co., Ltd., was deposited to a thickness of 30 μm so as to cover the decoration layer and the flow reducing members arranged on the decoration layer.

A formed product was decorated within a vacuum forming system with a decorative sheet obtained in this manner. As a result, fine appearance was realized without producing strings of uneven gloss.

### Example #2

A decorative sheet was made as in the first specific example described above except that the flow reducing members had a diameter of 5 mm and a thickness of 5 μm and were arranged at an interval of 5 mm. A formed product was decorated within a vacuum forming system with a decorative sheet obtained in this manner. As a result, as in the first specific example just described, fine appearance was realized without producing strings of uneven gloss.

### Example #3

A decorative sheet was made as in the first specific example described above except that the adhesive layer was deposited to a thickness of 100 μm. A formed product was decorated within a vacuum forming system with a decorative sheet obtained in this manner. As a result, as in the first specific example just described, fine appearance was realized without producing strings of uneven gloss.

### Example #4

A decorative sheet was made as in the first specific example described above except that the flow reducing members were arranged in a ring pattern with an outside diameter of 4 mm and an inside diameter of 3.5 mm. A formed product was decorated within a vacuum forming system with a decorative sheet obtained in this manner. As a result, fine appearance was also realized without producing strings of uneven gloss. The appearance realized by this specific example was superior to that realized by the first specific example.

### Comparative Example

A polycarbonate film Eupiron D02, produced by Mitsubishi Gas Chemical Co., Inc. and having a thickness of 0.5 mm, was used as a base member and a decoration layer was formed on this film by an evaporation process. Thereafter, a urethane based adhesive UNH790, produced by Nihon Unipolymer Co., Ltd., was deposited on this decoration layer to form an adhesive layer with a thickness of 30 μm.

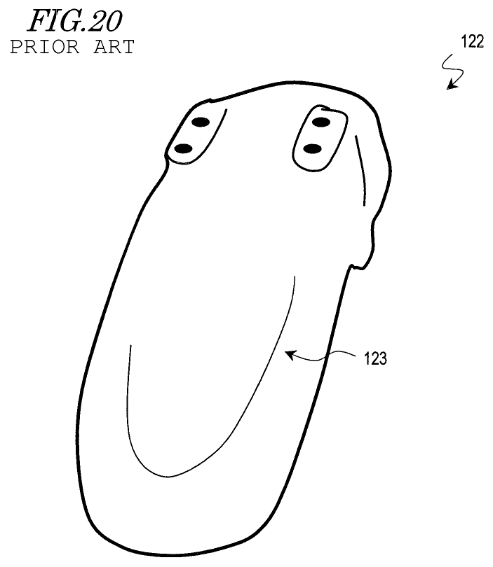

A formed product was decorated within a vacuum forming system with a decorative sheet obtained in this manner. As a result, strings of uneven gloss were produced as shown in FIG. 20 to ruin its fine appearance.

Preferred embodiments of the present invention provide a decorative sheet that can decorate a formed product without diminishing the beauty of its appearance.

The appearance of a formed product decorated with the decorative sheet according to preferred embodiments of the present invention is so fine that the product can be used effectively as an exterior or interior member for any of various motor vehicles or as an exterior member for any of numerous consumer electronic appliances.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

1-16. (canceled)

17. A decorative sheet for use to decorate a formed product, the sheet comprising:
a decoration layer;
a base member that supports the decoration layer;
an adhesive layer arranged to adhere the decoration layer and the base member onto the formed product; and
a flow reducing member arranged to reduce the flow of the adhesive layer, the flow reducing member being provided in the adhesive layer and being made of a material having a higher melting point than that of a material of the adhesive layer.

18. The decorative sheet of claim 17, wherein the flow reducing member is fixed on the decoration layer.

19. The decorative sheet of claim 18, wherein the adhesive layer is arranged so as to cover the decoration layer and the flow reducing member that is fixed on the decoration layer.

20. The decorative sheet of claim 17, wherein the melting point of the material of the flow reducing member is higher than that of the material of the adhesive layer by at least about 20° C.

21. The decorative sheet of claim 17, wherein the elasticity of the material of the flow reducing member is at least twice as high as that of the material of the adhesive layer at about 80° C.

22. The decorative sheet of claim 17, wherein the flow reducing member has a recess on its surface that is in contact with the adhesive layer.

23. The decorative sheet of claim 22, wherein the thinnest portion of the flow reducing member with the recess is at most about two-thirds as thick as the thickest portion thereof.

24. The decorative sheet of claim 17, comprising a plurality of flow reducing members.

25. The decorative sheet of claim 24, wherein the flow reducing members are arranged at regular intervals.

26. The decorative sheet of claim 17, wherein the melting point of the material of the adhesive layer is lower than the glass transition temperature of the material of the base member by at least about 30° C.

27. The decorative sheet of claim 17, wherein the material of the base member is a resin.

28. The decorative sheet of claim 27, wherein the resin is a thermoplastic resin.

29. A decorated formed product comprising:
a formed product; and
the decorative sheet of claim 17 that has been bonded to the surface of the formed product.

30. The decorated formed product of claim 29, wherein the formed product has been formed by a deep-drawing process and has such a shape that a draw diameter L and a draw depth D satisfy L≧100 mm and D/L≧⅓.

31. The decorated formed product of claim 29, wherein an outer surface of the decorative sheet bonded to the surface of the formed product has a ruggedness corresponding to an arrangement pattern of the flow reducing members.

32. A motor vehicle comprising the decorated formed product of claim 29.
